(19) United States
(12) Patent Application Publication
(10) Pub. No.: US 2025/0038249 A1
(43) Pub. Date: Jan. 30, 2025

(54) RECHARGEABLE LITHIUM BATTERY

(71) Applicant: SAMSUNG SDI CO., LTD., Yongin-si (KR)

(72) Inventors: Youngkyeong SHIN, Yongin-si (KR); Arum YU, Yongin-si (KR); Tae Hyon BAE, Yongin-si (KR); Harim LEE, Yongin-si (KR); Sanghyung KIM, Yongin-si (KR); Seunghyeon SON, Yongin-si (KR); Sanghoon KIM, Yongin-si (KR)

(21) Appl. No.: 18/749,353

(22) Filed: Jun. 20, 2024

(30) Foreign Application Priority Data
Jul. 27, 2023 (KR) 10-2023-0098397
Apr. 17, 2024 (KR) 10-2024-0051557

(51) Int. Cl. H01M 10/052; H01M 4/02; H01M 4/38; H01M 4/525; H01M 4/583; H01M 10/0567; H01M 10/0568; H01M 10/0569

(52) U.S. Cl. CPC H01M 10/052; H01M 4/386; H01M 4/525; H01M 4/583; H01M 10/0567; H01M 10/0568; H01M 10/0569; H01M 2004/021; H01M 2004/027; H01M 2004/028; H01M 2300/0037

(57) ABSTRACT

A lithium secondary battery includes: a positive electrode including a positive electrode active material; a negative electrode including a negative electrode active material; and an electrolyte, wherein the negative electrode has a composite density of at least 1.7 g/cc, and the electrolyte includes a lithium salt, a non-aqueous organic solvent, a first additive represented by Formula 1, a second additive represented by Formula 2, and a third additive represented by Formula 3:

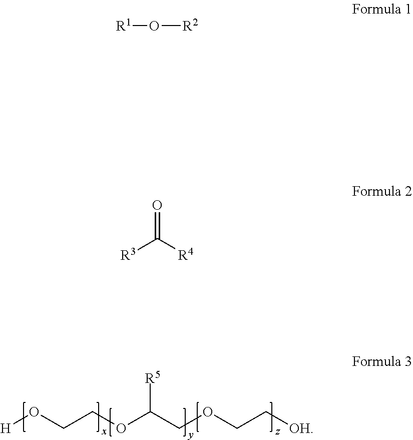

### CROSS-REFERENCE TO RELATED APPLICATION

The present application claims priority to and the benefit of Korean Patent Application Nos. 10-2023-0098397, filed on Jul. 27, 2023, and 10-2024-0051557, filed on Apr. 17, 2024, in the Korean Intellectual Property Office, the entire content of each of the two applications is incorporated herein by reference.

### BACKGROUND

### 1. Field

One or more embodiments of the present disclosure relate to lithium secondary batteries.

### 2. Description of the Related Art

In recent years, the demand for relatively energy-dense and high-capacity secondary batteries has increased rapidly with the rapid spread and popularization of electronic devices that use batteries, such as cell phones, notebook computers, and/or electric vehicles. As a result, research and development to improve the performance of lithium secondary batteries is actively underway or being pursed.

A lithium secondary battery is a battery that includes a positive electrode and a negative electrode each including an active material capable of intercalating and deintercalating lithium ions, and an electrolyte solution to generate electrical energy by oxidation and reduction reactions when lithium ions are intercalated or deintercalated at the positive electrode and the negative electrode.

One of the recent developments in lithium secondary batteries is to densify the negative electrode. However, densifying the negative electrode reduces the void volume of the negative electrode, which increases the amount of an electrolyte impregnating the negative electrode (e.g., rather than being accommodated in the void volume); as a result, the thickness of the battery (e.g., battery cell) increases, and the lifetime of the battery is reduced.

### SUMMARY

One or more aspects of embodiments of the present disclosure are directed toward a lithium secondary battery that densifies the negative electrode while suppressing the increase in thickness and decrease in lifetime of the battery.

Additional aspects will be set forth in part in the description which follows and, in part, will be apparent from the description, or may be learned by practice of the presented embodiments of the disclosure.

According to one or more embodiments of the present disclosure, a lithium secondary battery includes: a positive electrode including a positive electrode active material; a negative electrode including a negative electrode active material; and an electrolyte, wherein the negative electrode has a composite density of at least 1.7 g/cc (gram/cubic centimeter), and the electrolyte includes: a lithium salt; a non-aqueous organic solvent; a first additive represented by Formula 1; a second additive represented by Formula 2; and a third additive represented by Formula 3:

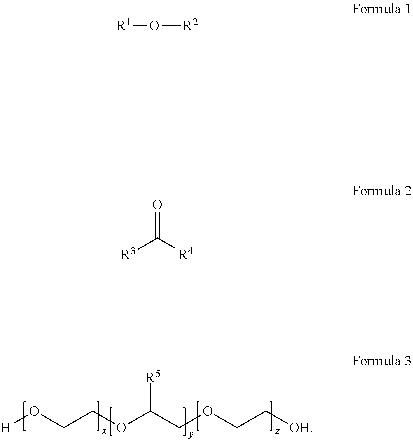

According to one or more embodiments, a lithium secondary battery may density a negative electrode while limiting the increase in thickness and decrease in lifetime of the lithium secondary battery.

### BRIEF DESCRIPTION OF THE DRAWINGS

The above and other aspects, features, and advantages of certain embodiments of the present disclosure will be more apparent from the following description taken in conjunction with the accompanying drawings.

FIGS. 1 through 4 are each a schematic diagram illustrating a lithium secondary battery according to one or more embodiments of the present disclosure.

### DETAILED DESCRIPTION

In the following, one or more embodiments of the present disclosure will be described in detail. However, these embodiments are presented by way of example only and embodiments of the present disclosure are not limited thereto, and the present disclosure is only defined by the scope of the appended claims and equivalents thereof.

Unless otherwise noted herein, when a layer, membrane, region, plate, etc. is said to be “on top of” or “on” another, this includes not only when it is “directly above” or “directly on” another, but also when there is another part (e.g., intervening part) therebetween. In contrast, “directly on” may refer to that there are no additional layer, membrane, region, plate, etc., between a layer, a membrane, a region, a plate, etc. and another. For example, “directly on” may refer to two layers or two members are disposed without utilizing an additional member such as an adhesive member therebetween.

In the present disclosure, unless otherwise indicated, references to the singular may include the plural. For example, the singular forms, “a,” “an,” “one,” and “the” are intended to include the plural forms as well, unless the context clearly indicates otherwise. In addition, unless otherwise noted, “A or B” or “A and/or B” may mean “including A, including B, or including A and B”. Further, the utilization of “may” when describing embodiments of the present disclosure refers to “one or more embodiments of the present disclosure”.

As used herein, “combinations thereof” may refer to mixtures, stacks, composites, copolymers, alloys, blends, and/or reaction products of components.

As used herein, the term “negative electrode composite density,” “composite density of negative electrode,” or “composite density” may refer to the value calculated by dividing the weight of the components (active materials (e.g., negative electrode active materials), conductors, binders, etc.) in the negative electrode (or an electrode), excluding the negative electrode current collector, by the volume of the components.

Unless otherwise defined in a formula in the disclosure, if (e.g., when) a chemical bond is not drawn where the chemical bond should be drawn, it means that a hydrogen is bonded at that location.

In the disclosure, unless otherwise defined, “*” means a portion of the same or different atoms or chemical formulas.

As used herein, “fluoroalkyl group” means an alkyl group in which some or all of the hydrogens are substituted by fluorine.

As used herein, “perfluoroalkyl group” means an alkyl group in which all of the hydrogens are replaced by fluorine.

### Lithium Secondary Battery

According to one or more embodiments of the present disclosure, a lithium secondary battery may include: a positive electrode including a positive electrode active material; a negative electrode including a negative electrode active material; and an electrolyte, wherein the negative electrode has a composite density of at least 1.7 g/cc, and the electrolyte includes: a lithium salt; a non-aqueous organic solvent; a first additive represented by Formula 1; a second additive represented by Formula 2; and a third additive represented by Formula 3:

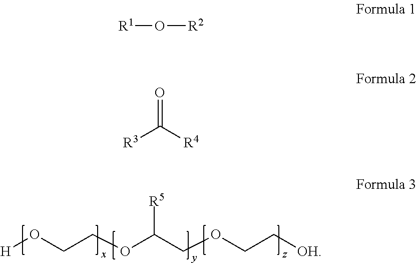

Each of the first additive and the third additive functions as a surfactant having both (e.g., simultaneously) hydrophilic and hydrophobic groups in one molecule.

The first additive may include an ether group at its center (e.g., as a core structure in the molecular structure of the first additive), flanked by fluorine atoms or fluoroalkyl groups having 1 to 10 carbon atoms (e.g., C1-C10 fluoroalkyl groups), wherein the ether group is hydrophilic, and the fluorine atoms or the fluoroalkyl group having 1 to 10 carbon atoms is hydrophobic.

The second additive may include a ketone group in the center of the molecular structure of the second additive (e.g., as a core structure in the molecular structure of the second additive), flanked by fluorine atoms or fluoroalkyl groups having 1 to 10 carbon atoms (e.g., C1-C10 fluoroalkyl). Here, the ketone group is hydrophilic, and the fluorine atoms or the fluoroalkyl group having 1 to 10 carbon atoms is hydrophobic.

The third additive may include a *—[O—CH(R⁵)—CH₂]_{y}—* block in the center of the molecular structure of the third additive (as a core structure in the molecular structure of the third additive) and a *—[O—CH₂—CH₂]ₓ—* block and a *—[O—CH₂—CH₂]_{z}—* block on either side thereof, respectively, wherein, the *—[O—CH(R⁵)—CH₂]_{y}—* block is a hydrophobic block, and the *—[O—CH₂—CH₂]ₓ—* block and the *—[O—CH₂—CH₂]_{z}—* block are each a hydrophilic block.

Therefore, if (e.g., when) the electrolyte containing the first additive and/or the third additive is used simultaneously, the wettability of the positive electrode and the negative electrode is improved, lithium cations (Li⁺) may be uniformly (e.g., substantially uniformly) formed at an interface of each of the positive electrode and the electrolyte, and a stable solid electrolyte interphase (SEI) film may be formed at the interface of each of the negative electrode and the electrolyte, and the precipitation of lithium dendrite is suppressed.

Therefore, by using the electrolyte solution including the first additive and the third additive simultaneously, the negative electrode may be densified to a composite density of 1.7 g/cc or more, while suppressing the thickness increase and life reduction of the lithium secondary battery (e.g., battery cell).

A lithium secondary battery according to one or more embodiments of the present disclosure will be described in more detail hereinafter.

### Composite Density of Negative Electrode

While comparative lithium secondary batteries in the art utilize negative electrodes with a composite density of less than 1.7 g/cc, lithium secondary batteries according to one or more embodiments of the present disclosure utilize negative electrodes with a composite density of equal to or greater than 1.7 g/cc.

An upper limit for the composite density of the negative electrode is not particularly limiting, but may be 2.0 g/cc or less, 1.9 g/cc or less, or 1.8 g/cc or less.

### Charge Upper Limit Voltage

In the lithium secondary battery according to one or more embodiments of the present disclosure, by using the electrolyte solution including the first additive and the third additive at the same time, the thickness increase and the decrease in the lifetime of the lithium secondary battery may be suppressed even at high voltage.

In one or more embodiments, the lithium secondary battery may have a charge upper limit voltage of 4.4 V or more.

### First Additive

In Formula 1, R¹ and R² may each independently be fluorine or a fluoroalkyl group having 1 to 10 carbon atoms.

In one or more embodiments, R¹ may be a fluoroalkyl group having 2 carbon atoms (e.g., a fluorinated ethyl group).

In one or more embodiments, R² may be a fluoroalkyl group having 3 carbon atoms (e.g., a fluorinated propyl group).

In one or more embodiments, the first additive may be represented by Formula 1-1:

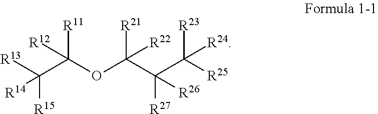

In Formula 1-1, R¹¹ to R¹⁵ may each independently be hydrogen or fluorine, wherein at least one selected from among R¹¹ to R¹⁵ is fluorine; and R²¹ to R²⁷ may each independently be hydrogen or fluorine, wherein at least one selected from among R²¹ to R²⁷ is fluorine.

Representative examples of the first additive may be an additive represented by Formula 1-1-1:

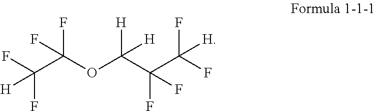

### Second Additive

In Formula 2, R³ and R⁴ may each independently be fluorine or a fluoroalkyl group having 1 to 10 carbon atoms.

In one or more embodiments, R³ may be a fluoroalkyl group or a perfluoroalkyl group each having 2 carbon atoms (e.g., a partially or fully fluorinated ethyl group).

In one or more embodiments, R⁴ may be a fluoroalkyl group or a perfluoroalkyl group each having 3 carbon atoms (e.g., a partially or fully fluorinated propyl group).

In one or more embodiments, the second additive may be represented by the formula 2-1:

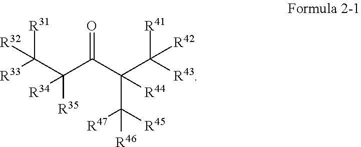

In Formula 2-1, R³¹ to R³⁵ may each independently be hydrogen or fluorine, wherein at least one selected from among R³¹ to R³⁵ is fluorine; and R⁴¹ to R⁴⁷ may each independently be hydrogen or fluorine, wherein at least one selected from among R⁴¹ to R⁴⁷ is fluorine.

Representative examples of the second additive may include an additive represented by Formula 2-1-1:

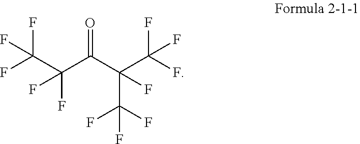 [SMILES: O=C(C(F)(F)C(F)(F)F)C(F)(C(F)(F)F)C(F)(F)F]

### Third Additive

In Formula 3, R⁵ may be hydrogen or an alkyl group having 1 to 10 carbon atoms.

In one or more embodiments, R⁵ may be a methyl group.

In Formula 3, x, y, and z may each independently be an integer from 1 to 20.

In one or more embodiments, a ratio (i.e., molar ratio) of x:y may be 10:1 to 1:10, 5:1 to 1:5, or 3:1 to 1:3. A ratio (i.e., molar ratio) of y:z may be 10:1 to 1:10, 5:1 to 1:5, or 3:1 to 1:3.

In one or more embodiments, a weight average molecular weight of the third additive may be 500 to 10,000 g/mol, 700 to 8,000 g/mol, or 1,000 to 2,000 g/mol. The weight average molecular weight may be measured by gel permeation chromatography (GPC).

If (e.g., when) the weight average molecular weight of the third additive is greater than 10,000 g/mol, the viscosity of the electrolyte containing the third additive may be excessively increased, and the wettability of the positive electrode and negative electrode may be reduced. On the other hand, if (e.g., when) the weight average molecular weight of the third additive is less than 1,000 g/mol, its effectiveness as a surfactant may be minimal.

Representative examples of the third additives may include an additive represented by Formula 3-1:

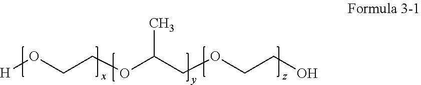

The third additive, represented by Formula 3-1, is poly(ethylene glycol)-b-poly(propylene glycol)-b-poly(ethylene glycol)) (Poly(ethylene glycol)-block-poly(propylene glycol)-block-poly(ethylene glycol), PEG-b-PPG-b-PEG).

In Formula 3-1, the definitions of x, y, and z may each be the same as described in Formula 3.

### Content of First Additive to Third Additive

According to one or more embodiments of the present disclosure, an amount of the first additive may be in a range from about 1 wt % to about 10 wt %, from about 1 wt % to about 7 wt %, or from about 1 wt % to about 5 wt %, based on 100 wt % of a total amount of the electrolyte.

If (e.g., when) the first additive is included in an excessive amount over the range described above, the viscosity of the electrolyte containing the first additive may be excessively increased, and the wettability to the positive electrode and negative electrode may be rather reduced. On the other hand, if (e.g., when) the content (e.g., amount) of the first additive is included in a small amount below the above range, its effectiveness as a surfactant may be minimal.

An amount of the second additive may be in a range from about 1 wt % to about 10 wt %, from about 1 wt % to about 7 wt %, or from about 1 wt % to about 5 wt %, based on 100 wt % of the total amount of the electrolyte.

If (e.g., when) the second additive is included in an excessive amount over the range described above, the viscosity of the electrolyte containing the second additive may be excessively increased, and the wettability to the positive electrode and negative electrode may be rather reduced. On the other hand, if (e.g., when) the content of (e.g., amount) the second additive is included in a small amount below the above range, its effectiveness as a surfactant may be insignificant.

An amount of the third additive may be in a range from about 1 wt % to about 10 wt %, from about 1 wt % to about 7 wt %, or from about 1 wt % to about 5 wt %, based on 100 wt % of the total amount of the electrolyte.

If (e.g., when) the third additive is included in an excessive amount over the range described above, the viscosity of the electrolyte containing the third additive may be excessively increased, and the wettability of the positive electrode and negative electrode may be reduced. On the other hand, if (e.g., when) the content (e.g., amount) of the third additive is included in a small amount below the above range, its effectiveness as a surfactant may be insignificant.

In one or more embodiments, for each 10 parts by weight of the first additive, the second additive may be from 1 to 100 parts by weight, and the third additive may be from 1 to 100 parts by weight.

In one or more embodiments, for every 10 parts by weight of the first additive, the second additive may be from 5 to 20 parts by weight, and the third additive may be from 5 to 20 parts by weight.

In one or more embodiments, for every 10 parts by weight of the first additive, the second additive may be from 5 to 20 parts by weight, and the third additive may be from 5 to 20 parts by weight.

In the above scope, the effects of the first additive and the third additive may be synergized and harmonized.

### Non-aqueous Organic Solvent

The non-aqueous organic solvent acts as a medium through which ions involved in electrochemical reactions in the lithium secondary battery (e.g., battery cell) may migrate.

The non-aqueous organic solvent may be a carbonate-based solvent, an ester-based solvent, an ether-based solvent, a ketone-based solvent, an alcohol-based solvent, an aprotic solvent, or a (e.g., any suitable) combination thereof.

The carbonate-based solvents may include dimethyl carbonate (DMC), diethyl carbonate (DEC), dipropyl carbonate (DPC), methylpropyl carbonate (MPG), ethylpropyl carbonate (EPC), methylethyl carbonate (MEG), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In one or more embodiments, the ketone-based solvent, such as cyclohexanone, may be used. The alcohol-based solvent may include ethyl alcohol, isopropyl alcohol, and/or the like, and the aprotic solvent may include nitriles such as R-CN (where R is a straight, branched, or cyclic hydrocarbon group having 2 to 20 carbon atoms, and may include double bonds, aromatic rings, or ether groups); amides, such as dimethylformamide; dioxolanes, such as 1,3-dioxolane, 1,4-dioxolane, and/or the like; and/or sulfolanes, such as sulfolane.

The non-aqueous organic solvent may be used alone or in a mixture of two or more thereof.

In one or more embodiments, the non-aqueous organic solvent may include a carbonate-based solvent and a propionate-based solvent.

The propionate-based solvent may be included, with respect to 100 volume % of a total amount (e.g., a total volume) of the non-aqueous organic solvent, at least 70 volume %. As such, the high voltage and/or high temperature characteristics of the lithium secondary battery may be improved.

In one or more embodiments, the non-aqueous organic solvent may be a mixture of ethylene carbonate (EC), propylene carbonate (PC), and propyl propionate (PP).

### Lithium Salt

The lithium salt may be a substance that is soluble in the non-aqueous organic solvent and acts as a source of lithium ions within the lithium secondary battery, enabling a basic operation of the lithium secondary battery and facilitating the migration of lithium ions between the positive electrode and negative electrode.

In one or more embodiments, LiPF₆ may be used as the lithium salt.

The concentration of the lithium salt may be in a range from 0.1 M to 2.0 M.

### Positive Electrode Active Material

As the positive electrode active material, a compound capable of reversible intercalation and deintercalation of lithium (reversible intercalation compound) may be used. In one or more embodiments, one or more of metals selected from cobalt, manganese, nickel, and combinations thereof, and their composite oxides with lithium may be used.

The composite oxide may be a lithium transition metal composite oxide, and non-limiting examples may include lithium nickel-based oxides, lithium cobalt-based oxides, lithium manganese-based oxides, lithium iron phosphate compounds, cobalt-free nickel-manganese-based oxides, or any combination thereof.

In one or more embodiments, a compound represented by any of (e.g., any one selected from) the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O₂₋ₐDₐ (0.90≤a≤1.8, 0≤b≤0.5, 0≤c≤0.5, 0<a<2); LiₐNi_{1-b-c}Mn_{b}X_{c}O₂₋ₐDₐ (0.90≤a≤1.8, 0≤b≤0.5, 0≤c≤0.5, 0<a<2); LiₐNi_{b}Co_{c}L1_{d}GₑO₂(0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and/or LiₐFePO₄(0.90≤a≤1.8).

In the above formulas, A may be nickel (Ni), cobalt (Co), manganese (Mn), or a (e.g., any suitable) combination thereof; X may be aluminum (Al), Ni, Co, Mn, chromium (Cr), iron (Fe), magnesium (Mg), strontium (Sr), vanadium (V), a rare earth element, or a (e.g., any suitable) combination thereof; D may be oxygen (O), fluorine (F), sulfur (S), phosphorous (P), or a (e.g., any suitable) combination thereof; G may be Al, Cr, Mn, Fe, Mg, lanthanum (La), cerium (Ce), Sr, V, or a (e.g., any suitable) combination thereof; and L1 may be Mn, Al, or a combination thereof.

In one or more embodiments, the positive electrode active material may be a high nickel-based positive electrode active material having a content (e.g., amount) of at least 80 mole %, at least 85 mole %, at least 90 mole %, at least 91 mole %, or at least 94 mole % and not more than 99 mole % of nickel per 100 mole % of metal(s) other than lithium in the lithium transition metal composite oxide. High-nickel positive electrode active materials may realize high capacity, which may be applied to high-capacity, high-density lithium secondary batteries.

In one or more embodiments, the positive electrode active material may include, for example, a lithium nickel-based oxide represented by Formula 11, a lithium cobalt-based oxide represented by Formula 12, a lithium iron phosphate-based compound represented by Formula 13, a cobalt-free lithium nickel-manganese-based oxide represented by Formula 14, or any combination thereof.

Liₐ₁Niₓ₁M1_{y1}M2_{z1}O_{2-b1}X_{b1} Formula 11

In Formula 11, 0.9≤a1≤1.8, 0.3≤x1≤1, 0≤y1≤0.7, 0≤z1≤0.7, 0.9≤x1+y1+z1≤1.1, and 0≤b1≤0.1, wherein M1 and M2 may each independently be one or more elements selected from the group consisting of aluminum (Al), boron (B), barium (Ba), calcium (Ca), cerium (Ce), cobalt (Co), chromium (Cr), copper (Cu), iron (Fe), magnesium (Mg), manganese (Mn), molybdenum (Mo), niobium (Nb), silicon (Si), tin (Sn), strontium (Sr), titanium (Ti), vanadium (V), tungsten (W), and zirconium (Zr), and X may be one or more elements selected from the group consisting of F, P, and S.

In some embodiments, in Formula 11, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M3_{y2}O_{2-b2}X_{b2} Formula 12

In Formula 12, 0.9≤a2≤1.8, 0.7≤x2≤1, 0≤y2≤0.3, 0.9≤x2+y2≤1.1, and 0≤b2≤0.1, wherein M3 may be one or more elements selected from the group consisting of aluminum (Al), boron (B), barium (Ba), calcium (Ca), cerium (Ce), chromium (Cr), copper (Cu), iron (Fe), magnesium (Mg), manganese (Mn), molybdenum (Mo), nickel (Ni), selenium (Se), silicon (Si), tin (Sn), strontium (Sr), titanium (Ti), vanadium (V), tungsten (W), yttrium (Y), zinc (Zn), and zirconium (Zr), and X may be one or more elements selected from the group consisting of F, P, and S.

Liₐ₃Feₓ₃M4_{y3}PO_{4-b3}X_{b3} Formula 13

In Formula 13, wherein 0.9≤a3≤1.8, 0.6≤x3≤1, 0≤y3≤0.4, and 0≤b3≤0.1, M4 may be one or more elements selected from the group consisting of Al, B, Ba, Ca, Ce, Co, Cr, Cu, Mg, Mn, Mo, Ni, Se, Si, Sn, Sr, Ti, V, W, Y, Zn, and Zr, and X may be one or more elements selected from the group consisting of F, P, and S.

Liₐ₄Niₓ₄Mn_{y4}M5_{z4}O_{2-b4}X_{b4} Formula 14

The formula 14, wherein 0.9≤a2≤1.8, 0.8≤x4<1, 0<y4≤0.2, 0≤z4≤0.2, 0.9≤x4+y4+z4≤1.1, and 0≤b4≤0.1, wherein M5 may be one or more elements selected from the group consisting of Al, B, Ba, Ca, Ce, Cr, Fe, Mg, Mo, Nb, Si, Sn, Sr, Ti, V, W, and Zr, and X may be one or more elements selected from the group consisting of F, P, and S.

In one or more embodiments of the present disclosure, the electrolyte of one or more embodiments described herein may exceptionally or substantially improve the high-voltage and/or high-temperature characteristics of a battery with a lithium cobalt-based oxide represented by Formula 12.

A positive electrode for a lithium secondary battery may include a positive electrode current collector and a positive electrode active material layer formed on the positive electrode current collector. The positive electrode active material layer may include a positive electrode active material (e.g., in a form of particles), and may further include a binder and/or a conductive material and/or a coating material.

In one or more embodiments, the positive electrode may further include an additive that may act as a sacrificial positive electrode material.

The content (e.g., amount) of the positive electrode active material may be in a range from about 90 wt % to about 99.5 wt % based on 100 wt % of a total weight of the positive electrode active material layer, and the content (e.g., amount) of each of the binder and the coating material may be in a range from about 0.5 wt % to about 5 wt % based on 100 wt % of the total weight of the positive electrode active material layer.

The binder serves to adhere the positive electrode active material particles to each other and also to adhere the positive electrode active material to the positive electrode current collector. Non-limiting examples of binders may include polyvinyl alcohol, carboxymethylcellulose, hydroxypropylcellulose, diacetylcellulose, polyvinyl chloride, carboxylated polyvinyl chloride, polyvinyl fluoride, polymers including ethylene oxide, polyvinylpyrrolidone, polyurethane, polytetrafluoroethylene, polyvinylidene fluoride, polyethylene, polypropylene, styrene-butadiene rubbers, (meth)acrylated styrene-butadiene rubbers, epoxy resins, (meth)acrylic resins, polyester resins, nylon, and/or the like.

The conductive material may be used to impart conductivity to the electrodes, and may be any electronically conductive material that does not cause chemical changes in the lithium secondary battery being constructed. Non-limiting examples of conductive materials may include natural graphite, artificial graphite, carbon black, acetylene black, quenched black, carbon-based materials such as carbon fibers, carbon nanofibers, carbon nanotubes, etc.; metal-based materials in the form of metal powders or metal fibers containing copper, nickel, aluminum, silver, etc.; conductive polymers such as polyphenylene derivatives; and/or mixtures thereof.

In one or more embodiments, Al (aluminum) may be used as a positive electrode current collector, but embodiments of the present disclosure are not limited to.

### Negative Electrode Active Material

Examples of negative electrode active materials may include materials capable of reversibly intercalating/de-intercalating lithium ions, lithium metals, alloys of lithium metals, materials capable of doping and de-doping lithium, and/or transition metal oxides.

The material capable of reversibly intercalating/de-intercalating lithium ions may include a carbon-based negative electrode active material, for example, crystalline carbon, amorphous carbon, or a (e.g., any suitable) combination thereof. Non-limiting examples of crystalline carbon may include graphite, such as natural or artificial graphite in an amorphous form, a plate form, a flake form, a spherical form, or a fibrous form, and non-limiting examples of amorphous carbon may include soft carbon or hard carbon, mesoporous pitch carbides, calcined coke, and/or the like.

As an alloy of the lithium metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and de-doping lithium, a Si-based negative electrode active material or a Sn-based negative electrode active material may be used. The Si-based negative electrode active material may be silicon, a silicon-carbon composite, SiOₓ (0<x≤2), a Si-Q alloy (wherein Q is selected from alkali metals, alkaline earth metals, Group 13 elements, Group 14 elements (excluding Si), Group 15 elements, Group 16 elements, transition metals, rare earth elements, and combinations thereof), or any combination thereof. The Sn-based negative electrode active material may be Sn, SnOₖ (0<k≤2) (e.g., SnO₂), a Sn-based alloy, or a (e.g., any suitable) combination thereof.

The silicon-carbon composite may be a composite of silicon and amorphous carbon. According to one or more embodiments, the silicon-carbon composite may be in the form of silicon particles and an amorphous carbon coating on a surface of each of the silicon particles. For example, in one or more embodiments, the silicon-carbon composite may include a secondary particle (core) in which silicon primary particles are assembled (e.g., agglomerated) and an amorphous carbon coating layer (shell) located on a surface of the secondary particle. The amorphous carbon may also be located between the silicon primary particles, such that, for example, the silicon primary particles are each coated with amorphous carbon. The secondary particles may be dispersed in an amorphous carbon matrix.

In one or more embodiments, the silicon-carbon composite may further include crystalline carbon. For example, in some embodiments, the silicon-carbon composite in the form of particles may include a core including crystalline carbon and silicon particles and an amorphous carbon coating layer located on a surface of the core.

In one or more embodiments, the Si-based negative electrode active material or Sn-based negative electrode active material may be used in combination with a carbon-based negative electrode active material.

A negative electrode for a lithium secondary battery may include a negative electrode current collector and a negative electrode active material layer on (e.g., disposed on) the negative electrode current collector. The negative electrode active material layer includes a negative electrode active material (e.g., in a form of particles), and may further include a binder and/or a conductive material and/or a coating material.

In one or more embodiments, the negative electrode active material layer may include about 90 wt % to about 99 wt % of the negative electrode active material, about 0.5 wt % to about 5 wt % of the binder, and 0 wt % to about 5 wt % of the conductive material.

The binder serves to adhere the negative electrode active material particles to each other and also to adhere the negative electrode active material to the negative electrode current collector. The binder may be a non-aqueous (e.g., water-insoluble) binder, an aqueous (e.g., water-soluble) binder, a dry binder, or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or any combination thereof.

The aqueous binder may be a rubber-based binder or a polymer resin binder. The rubber-based binder may be selected from among a styrene-butadiene rubber, an acrylated styrene-butadiene rubber (SBR), an acrylonitrile-butadiene rubber, an acrylic rubber, a butyl rubber, a fluorine rubber, and/or combinations thereof. The polymer resin binder may be selected from among polyphosphazene, poly(meth)acrylonitrile, ethylene propylene diene copolymer, polyvinylpyridine, chlorosulfonated polyethylene, latex, a polyester resin, a (meth)acrylic resin, a phenolic resin, an epoxy resin, polyvinyl alcohol, and/or combinations thereof.

In some embodiments, when an aqueous binder is used as a binder for the negative electrode, the binder may further include a cellulose-based compound capable of imparting viscosity. The cellulose-based compound may include one or more of carboxymethyl cellulose, hydroxypropylmethyl cellulose, methyl cellulose, and/or alkali metal salts thereof. The alkali metal may be Na, K, or U.

The dry binder may be a fibrous polymeric material, for example, polytetrafluoroethylene, polyvinylidene fluoride, a polyvinylidene fluoride-hexafluoropropylene copolymer, polyethylene oxide, or a (e.g., any suitable) combination thereof.

The conductive material used to impart conductivity to the negative electrodes may be any electronically conductive material that does not undergo chemical modification in the lithium secondar battery being constructed. Non-limiting examples of the conductive material may include natural graphite, artificial graphite, carbon black, acetylene black, quenched black, carbon-based materials such as carbon fibers, carbon nanofibers, carbon nanotubes, etc.; metal-based materials in the form of metal powders or metal fibers, including copper, nickel, aluminum, silver, and/or the like; conductive polymers such as polyphenylene derivatives; and/or mixtures thereof.

The negative electrode current collector may be selected from among copper foil, nickel foil, stainless steel foil, titanium foil, nickel foam, copper foam, polymer substrates coated with conductive metals, and combinations thereof.

### Separators

Depending on the type of lithium secondary battery, in one or more embodiments, a separator may also be present between the positive electrode and the negative electrode. The separator may be polyethylene, polypropylene, polyvinylidene fluoride, or two or more multilayers thereof, as well as mixed multilayers such as a polyethylene/polypropylene two-layer separator, a polyethylene/polypropylene/polyethylene three-layer separator, a polyethylene/polyethylene/polypropylene three-layer separator, etc.

The separator may include a porous substrate and a coating layer including an organic material, an inorganic material, or a combination thereof located on one or both (e.g., two opposite) sides of the porous substrate.

The porous substrate may be made of polyolefins such as polyethylene, polypropylene, polyesters such as polyethylene terephthalate, polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, glass fiber, and/or polytetrafluoroethylene (e.g., Teflon), or a polymeric film formed from a copolymer or a mixture of two or more of these polymers.

The organic material may include polyvinylidene fluoride-based polymers and/or (meth)acrylic-based polymers.

The inorganic material may include, but is not limited to, inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof.

The organic material and the inorganic material may be present in a mixture in one coating layer or may be present in the form of a coating layer including the organic material and a coating layer including the inorganic material laminated together.

### Lithium Secondary Battery

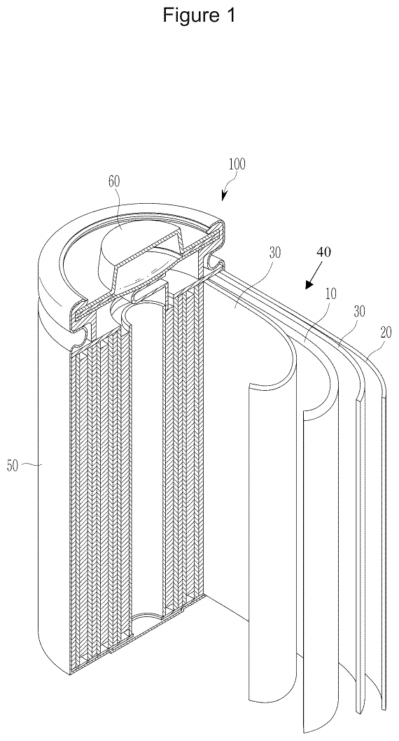

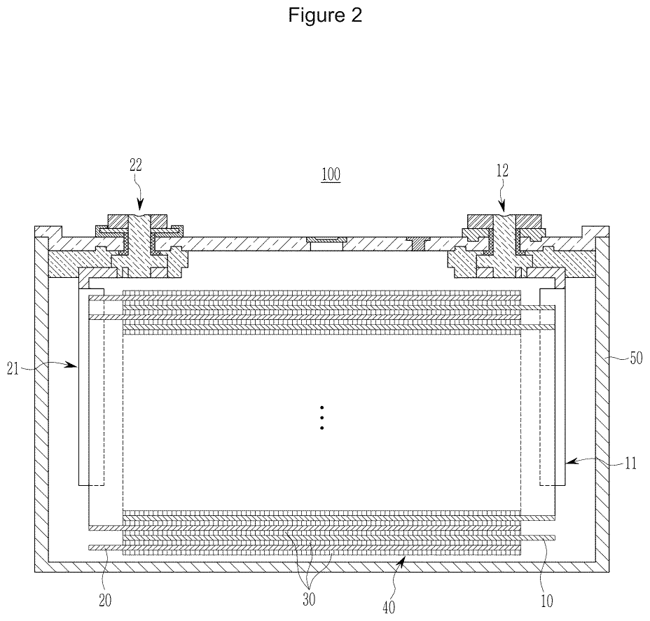

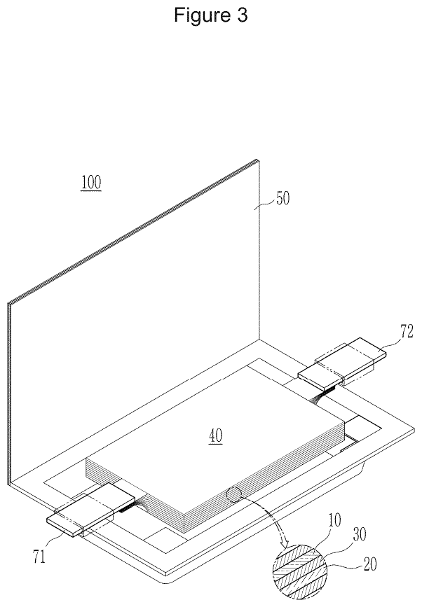

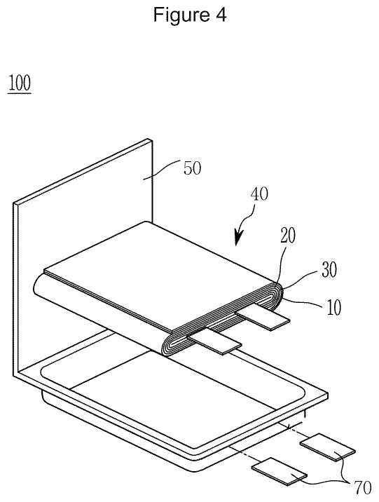

Lithium secondary batteries may be categorized as cylindrical, prismatic, pouch-like, coin-like, and/or the like based on their shapes. FIGS. 1 to 4 are each a schematic diagram illustrating a lithium secondary battery according to one or more embodiments, wherein FIG. 1 illustrates a cylindrical lithium secondary battery, FIG. 2 illustrates a prismatic lithium secondary battery, and FIGS. 3 and 4 each illustrate a lithium secondary battery having a pouch-type shape. Referring to FIGS. 1 through 4, a lithium secondary battery 100 may include an electrode assembly 40 having a separator 30 interposed between a positive electrode 10 and a negative electrode 20, and a case 50 in which the electrode assembly 40 is housed. The positive electrode 10, the negative electrode 20, and the separator 30 may be impregnated with an electrolyte (not shown). In some embodiments, the lithium secondary battery 100 may include a sealing member 60 that seals the case 50, as shown in FIG. 1. In some embodiments, as shown in FIG. 2, the lithium secondary battery 100 may include a positive lead tab 11 and a positive terminal 12, a negative lead tab 21 and a negative terminal 22. In some embodiments, as shown in FIG. 3 and FIG. 4, the lithium secondary battery 100 may include electrode tabs 70, namely a positive tab 71 and a negative tab 72, that serve as electrical pathways for directing current formed in the electrode assembly 40 to the outside.

Lithium secondary batteries according to one or more embodiments of the present disclosure may be applied in automobiles, cell phones, and/or various other forms of electrical devices, and embodiments of the present disclosure are not limited thereto.

Examples and comparative examples of the present disclosure will be described in more detail hereafter. However, the following examples are only example embodiments of the present disclosure and embodiments of the present disclosure are not limited to the following examples.

### EXAMPLES AND COMPARATIVE EXAMPLES

The electrolyte and the lithium secondary batteries were prepared as described below.

### Example 1

### (1) Preparation of Electrolyte

An electrolyte solution was prepared by dissolving 1.3 M of LiPF₆ in a non-aqueous organic solvent including a mixture of ethylene carbonate (EC), propylene carbonate (PC), and propyl propionate (PP) in a volume ratio of 10:15:75, and adding 1 wt % of a first additive, 1 wt % of a second additive, and 1 wt % of a third additive (based on 100 wt % of a total weight of the electrolyte).

The first additive is represented by Formula 1-1-1, the second additive is represented by Formula 2-1-1, and the third additive is represented by Formula 3-1:

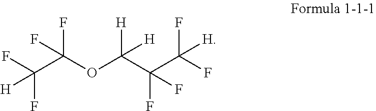

1,1,2,2-Tetrafluoroethyl-2,2,3,3-tetrafluoropropylether (CAS No.: 16627-68-2)

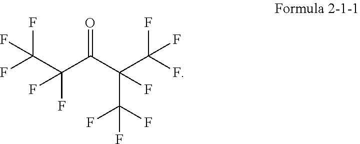 [SMILES: O=C(C(F)(F)C(F)(F)F)C(F)(C(F)(F)F)C(F)(F)F]

Perfluoro(2-methyl-3-pentanone) (CAS No.: 756-13-8)

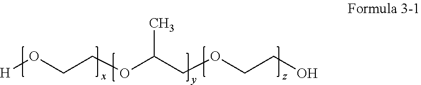

Poly(ethylene glycol)-block-poly(propylene glycol)-block-poly(ethylene glycol) (PEG-b-PPG- b-PEG. CAS No.: 9003-11-6, x=1-20, y=1-20, z=1-20, weight average molecular weight: 1,100 g/mol)

### (2) Manufacturing of Lithium Secondary Batteries

LiCoO₂ as a positive electrode active material, polyvinylidene fluoride as a binder, and acetylene black as a conductive material were mixed in a weight ratio of 96:3:1, respectively, and dispersed in N-methyl pyrrolidone to prepare a positive electrode active material slurry.

The positive electrode active material slurry was coated on a 15 microns (μm) thick Al foil, dried at 100° C., and rolled to prepare a positive electrode.

Artificial graphite was used as a negative electrode active material, and a negative electrode active material slurry was prepared by mixing the negative electrode active material with styrene-butadiene rubber binder and carboxymethylcellulose in a weight ratio of 98:1:1, respectively, and dispersing it in distilled water.

The negative electrode active material slurry was coated on a 10 μm thick Cu foil, dried at 100° C., and pressed to prepare a negative electrode. At this time, the negative electrode was made to have a composite density of 1.7 g/cc.

An electrode assembly was prepared by assembling the positive electrode and the negative electrode with a separator made of polyethylene having a thickness of 10 μm, and a lithium secondary battery (e.g., battery cell) was prepared by injecting the electrolyte.

### Example 2

The electrolyte and the lithium secondary battery (e.g., battery cell) were each prepared in substantially the same manner as in Example 1, except that 1 wt % of the first additive, 2 wt % of the second additive, and 1 wt % of the third additive were each added during the preparation of the electrolyte.

### Example 3

The electrolyte and the lithium secondary battery were each prepared in substantially the same manner as in Example 1, except that 1 wt % of the first additive, 1 wt % of the second additive, and 2 wt % of the third additive were each added in the preparation of the electrolyte.

### Example 4

The electrolyte and the lithium secondary battery were each prepared in substantially the same manner as in Example 1, except that 2 wt % of the first additive, 2 wt % of the second additive, and 2 wt % of the third additive were each added in the preparation of the electrolyte.

### Example 5

The electrolyte and the lithium secondary battery were each prepared in substantially the same manner as in Example 1, except that 5 wt % of the first additive, 5 wt % of the second additive, and 5 wt % of the third additive were each added in the preparation of the electrolyte.

### Example 6

The electrolyte and the lithium secondary battery were each prepared in substantially the same manner as in Example 1, except that 2 wt % of the first additive, 2 wt % of the second additive, and 2 wt % of the third additive were each added during the preparation of the electrolyte, and the negative electrode was prepared such that a composite density was 1.75 g/cc.

### Example 7

The electrolyte and the lithium secondary battery were each prepared in substantially the same manner as in Example 1, except that 2 wt % of the first additive, 2 wt % of the second additive, and 2 wt % of the third additive were each added during the preparation of the electrolyte, and the negative electrode was prepared so that a composite density was 1.8 g/cc.

### Comparison Example 1

The electrolyte and the lithium secondary battery were each prepared in substantially the same manner as in Example 1, except that no additives were added during the electrolyte preparation, and the negative electrode preparation resulted in a composite density of 1.65 g/cc.

### Comparison Example 2

The electrolyte and the lithium secondary battery were each prepared in substantially the same manner as in Example 1, except that no additives were added during the electrolyte preparation, and the negative electrode preparation resulted in a composite density of 1.67 g/cc.

### Comparison Example 3

The electrolyte and the lithium secondary battery were each prepared in substantially the same manner as in Example 1, except that no additives were added during the electrolyte preparation, and the negative electrode preparation resulted in a composite density of 1.7 g/cc.

### Comparison Example 4

The electrolyte and the lithium secondary battery were each prepared in substantially the same manner as in Example 1, except that the second additive and third additive were not added during the preparation of the electrolyte, 1 wt % of the first additive was added, and the composite density was 1.7 g/cc during the preparation of the negative electrode.

### Comparison Example 5

The electrolyte and the lithium secondary battery were each prepared in substantially the same manner as in Example 1, except that the first additive and third additive were not added during the preparation of the electrolyte, 1 wt % of the second additive was added, and the composite density was 1.7 g/cc during the preparation of the negative electrode.

### Comparison Example 6

The electrolyte and the lithium secondary battery were each prepared in substantially the same manner as in Example 1, except that the first additive and second additive were not added during the preparation of the electrolyte, the third additive of 1 wt % was added, and the negative electrode was prepared so that the composite density was 1.7 g/cc.

### Evaluation

The negative electrodes and the lithium secondary batteries were each evaluated using the following methods.

### Evaluation 1: Impregnation of the Electrolyte to the Negative Electrode

The negative electrode according to Example 1 was prepared as a specimen of L*W=3 cm*4 cm. 1 g of the electrolyte solution according to Example 1 was dropped on the specimen and left for 1 minute. Then, the amount of electrolyte immersed in the specimen out of 100 wt % of the electrolyte dropped on the specimen was evaluated on a scale of 0 to 5 according to the following criteria, and the evaluation results are shown in Table 1.

0: The amount of electrolyte impregnated in the specimen is greater than 0 wt % and less than 10 wt %.

1: The amount of electrolyte impregnated in the specimen is greater than 10 wt % and less than 20 wt %.

2: The amount of electrolyte impregnated in the specimen is greater than 20 wt % and less than 40 wt %.

3: The amount of electrolyte impregnated in the specimen is greater than 40 wt % and less than 60 wt %.

4: The amount of electrolyte impregnated in the specimen is greater than 60 wt % and less than 80 wt %.

5: The amount of electrolyte impregnate in the specimen is greater than 80 wt % and less than 100 wt %.

Examples 2 through 7 and Comparison Examples 1 through 6 were each evaluated in substantially the same manner, and the results of the evaluation are shown in Table 1 below.

TABLE 1

| | Composite | | | | Impregnability |
|---|---|---|---|---|---|
| | density of | Content of additives | | | of electrolyte |
| | negative | in the electrolyte (wt %) | | | for the |
| | electrode | First | Second | Third | negative |
| | (g/cc) | additive | additive | additive | electrode |
| Com | 1.65 | 0 | 0 | 0 | 2 |
| parison | | | | | |
| Example | | | | | |
| 1 | | | | | |
| Com | 1.67 | 0 | 0 | 0 | 1 |
| parison | | | | | |
| Example | | | | | |
| 2 | | | | | |
| Com | 1.7 | 0 | 0 | 0 | 0 |
| parison | | | | | |
| Example | | | | | |
| 3 | | | | | |
| Com | 1.7 | 1 | 0 | 0 | 1 |
| parison | | | | | |
| Example | | | | | |
| 4 | | | | | |
| Com | 1.7 | 0 | 1 | 0 | 1 |
| parison | | | | | |
| Example | | | | | |
| 5 | | | | | |
| Com | 1.7 | 0 | 0 | 1 | 1 |
| parison | | | | | |
| Example | | | | | |
| 6 | | | | | |
| Example 1 | 1.7 | 1 | 1 | 1 | 5 |
| Example 2 | 1.7 | 1 | 2 | 1 | 4 |
| Example 3 | 1.7 | 1 | 1 | 2 | 3 |
| Example 4 | 1.7 | 2 | 2 | 2 | 3 |
| Example 5 | 1.7 | 5 | 5 | 5 | 3 |
| Example 6 | 1.75 | 2 | 2 | 2 | 3 |
| Example 7 | 1.8 | 2 | 2 | 2 | 3 |

### Evaluation 2: Evaluate Room Temperature Charge/Discharge Cycle Characteristics

The lithium secondary battery was subjected to 400 charge and discharge cycles at 25° C., 2.0 C charge (CC/CV, 4.47 V, 0.025 C Cut-off)/1.0 C discharge (CC, 3 V Cut-off).

The thickness growth rate is calculated according to Equation 1, and the capacity retention rate is calculated according to Equation 2, and the results are shown in Table 2 below.

$$Thcikness growth rate = \{ ( full thickness after 400 cycles ) - ( full thickness after 1 cycle ) \} / \\ ( full thickness after 1 cycle ) * 100 \qquad Equation 1$$

In Equation 1, “full charge thickness” means the thickness of the lithium secondary battery measured after each cycle of charging to SOC 100% (full charge capacity of the battery, charged to 100% charge capacity).

$$Capacity retention rate = ( discharge capacity after 400 cycles / discharge \\ capacity after 1 cycle ) * 100 \qquad Equation 2$$

TABLE 2

| | | | | | Lithium Secondary Battery | |
|---|---|---|---|---|---|---|
| | | | | | Room temperature charge | |
| | Composite | | | | and discharge | |
| | density of | Content of additives in | | | characteristics | |
| | negative | the electrolyte (wt %) | | | Thickness | Capacity |
| | electrode | First | Second | Third | growth | retention |
| | (g/cc) | Additive | additive | additive | (%) | (%) |
| Comparison | 1.65 | 0 | 0 | 0 | 13.5 | 82.0 |
| Example 1 | | | | | | |
| Comparison | 1.67 | 0 | 0 | 0 | 15.2 | 79.2 |
| Example 2 | | | | | | |
| Comparison | 1.7 | 0 | 0 | 0 | 17.6 | 75.3 |
| Example 3 | | | | | | |
| Comparison | 1.7 | 1 | 0 | 0 | 18.1 | 74.7 |
| Example 4 | | | | | | |
| Comparison | 1.7 | 0 | 1 | 0 | 18.5 | 74.2 |
| Example 5 | | | | | | |
| Comparison | 1.7 | 0 | 0 | 1 | 19.2 | 73.5 |
| Example 6 | | | | | | |
| Example 1 | 1.7 | 1 | 1 | 1 | 3.2 | 89.0 |
| Example 2 | 1.7 | 1 | 2 | 1 | 3.9 | 88.0 |
| Example 3 | 1.7 | 1 | 1 | 2 | 4.1 | 87.2 |
| Example 4 | 1.7 | 2 | 2 | 2 | 5.3 | 86.5 |
| Example 5 | 1.7 | 5 | 5 | 5 | 12.2 | 83.2 |
| Example 6 | 1.75 | 2 | 2 | 2 | 8.2 | 85.0 |
| Example 7 | 1.8 | 2 | 2 | 2 | 10.1 | 84.1 |

Referring to Tables 1 and 2, when using an electrolyte without any additives (Comparative Examples 1 to 3), increasing the composite density of the negative electrode from 1.65 g/cc to 1.7 g/cc decreases the impregnation of the electrolyte to the negative electrode, increases the thickness of the lithium secondary battery, and decreases the lifetime of the lithium secondary battery.

However, when the negative electrode has the same composite density of 1.7 g/cc, compared to the case of using an electrolyte without any additive (Comparative Example 3), the impregnation of the negative electrode with the electrolyte including the first additive and the second additive simultaneously (Examples 1 to 5) increases, the thickness growth of the lithium secondary battery during charging and discharging decreases, and the lifetime of the lithium secondary battery increases.

On the other hand, if an electrolyte solution including only one of the first additive or the third additive is used (Comparative Examples 4 to 6), an SEI film is unstably formed on the surface of the negative electrode, resulting in lithium dendrite growth, and the capacity retention rate during charge and discharge plummets. Therefore, it is beneficial and desirable to use an electrolyte containing both the first additive and the third additive.

Furthermore, when an electrolyte solution including the first additive and the third additive simultaneously is used, the increase in thickness and decrease in lifetime of the lithium secondary battery during charge and discharge are suppressed even if the composite density of the negative electrode is increased from 1.7 g/cc to 1.8 g/cc (Examples 6 and 7).

In the present disclosure, the term “comprise(s)/comprising” “include(s)/including”, or “have(has)/having” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and equivalents thereof.

### REFERENCE NUMERALS

| | |
|---|---|
| 100: Lithium secondary battery | 10: Positive electrode |
| 11: Positive lead tab | 12: Positive terminal |
| 20: Negative electrode | 21: Negative electrode lead tab |
| 22: Negative terminal | 30: Separator |
| 40: Electrode assembly | 50: Case |
| 60: Sealing member | 70: Electrode tabs |
| 71: Positive electrode tab | 72: Negative electrode tab |

What is claimed is:

1. A lithium secondary battery, comprising:
a positive electrode comprising a positive electrode active material;
a negative electrode comprising a negative electrode active material; and
an electrolyte,
wherein,
the negative electrode has a composite density of at least 1.7 g/cc, and
the electrolyte comprises:
a lithium salt;
a non-aqueous organic solvent;
a first additive represented by Formula 1;
a second additive represented by Formula 2; and
a third additive represented by Formula 3:
R¹—O—R² Formula 1
in Formula 1,
R¹ and R² being each independently fluorine or a fluoroalkyl group having 1 to 10 carbon atoms; 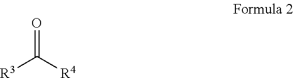
in Formula 2,
R³ and R⁴ being each independently fluorine or a fluoroalkyl group having 1 to 10 carbon atoms; and 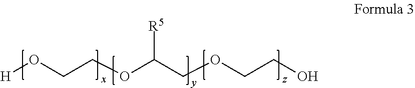
in Formula 3,
R⁵ being hydrogen or an alkyl group having 1 to 10 carbon atoms, and
x, y, and z being each independently an integer from 1 to 20.

2. The lithium secondary battery as claimed in claim 1, wherein the first additive is represented by Formula 1-1: 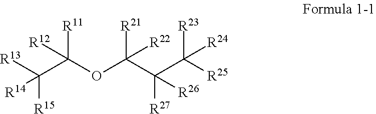
in Formula 1-1,
R¹¹ to R¹⁵ being each independently hydrogen or fluorine, and at least one selected from among R¹¹ to R¹⁵ being fluorine, and
R²¹ to R²⁷ being each independently hydrogen or fluorine, and at least one selected from among R²¹ to R²⁷ being fluorine.

3. The lithium secondary battery as claimed in claim 2, wherein the first additive is represented by Formula 1-1-1:

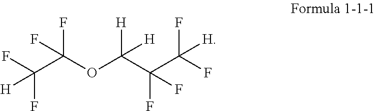

4. The lithium secondary battery as claimed in claim 1, wherein the second additive is represented by Formula 2-1: 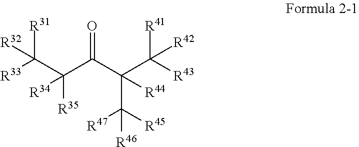
in Formula 2-1,
R³¹ to R³⁵ being each independently hydrogen or fluorine, and at least one selected from among R³¹ to R³⁵ being fluorine, and
R⁴¹ to R⁴⁷ being each independently hydrogen or fluorine, and at least one selected from among R⁴¹ to R⁴⁷ being fluorine.

5. The lithium secondary battery as claimed in claim 4, wherein the second additive is represented by Formula 2-1-1:

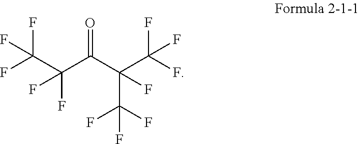 [SMILES: O=C(C(F)(F)C(F)(F)F)C(F)(C(F)(F)F)C(F)(F)F]

6. The lithium secondary battery as claimed in claim 1, wherein in Formula 3, R⁵ is a methyl group.

7. The lithium secondary battery as claimed in claim 1, wherein the third additive has a weight average molecular weight of 500 to 10,000 g/mol.

8. The lithium secondary battery as claimed in claim 1, wherein an amount of the first additive in the electrolyte is in a range from about 1 wt % to about 10 wt %, based on 100 wt % of a total amount of the electrolyte.

9. The lithium secondary battery as claimed in claim 1, wherein
an amount of the second additive in the electrolyte is in a range from about 1 wt % to about 10% by weight, based on 100 wt % of a total amount of the electrolyte.

10. The lithium secondary battery as claimed in claim 1, wherein
an amount of the third additive in the electrolyte is in a range from about 1 wt % to about 10 wt %, based on 100 wt % of a total amount of the electrolyte.

11. The lithium secondary battery as claimed in claim 1, wherein
for each 10 parts by weight of the first additive, the second additive is from 1 part to 100 parts by weight, and the third additive is from 1 part to 100 parts by weight.

12. The lithium secondary battery as claimed in claim 1, wherein
the non-aqueous organic solvent comprises a carbonate-based solvent and a propionate-based solvent.

13. The lithium secondary battery as claimed in claim 12, wherein
the propionate-based solvent comprises at least 70 volume %, relative to a total volume of 100 volume % of the non-aqueous organic solvent.

14. The lithium secondary battery as claimed in claim 1, wherein
the lithium salt is LiPF₆.

15. The lithium secondary battery as claimed in claim 1, wherein
the lithium salt has a concentration of 0.1 M to 2.0 M.

16. The lithium secondary battery as claimed in claim 1, wherein
the positive electrode active material comprises a lithium nickel-based oxide, a lithium cobalt-based oxide, a lithium manganese-based oxide, a lithium iron phosphate-based compound, a cobalt-free nickel-manganese-based oxide, or a combination thereof.

17. The lithium secondary battery as claimed in claim 1, wherein
the negative electrode active material comprises a carbon-based negative electrode active material, a Si-based negative electrode active material, or a combination thereof.

18. The lithium secondary battery as claimed in claim 1, wherein
a charging upper limit voltage of the lithium secondary battery is 4.4 V or higher.
